(19) United States
(12) Patent Application Publication
(10) Pub. No.: US 2025/0286853 A1
(43) Pub. Date: Sep. 11, 2025

(54) METHOD FOR DISPLAYING COMBINED CONTENT IN MESSAGING SERVICE, SERVER, AND USER TERMINAL

(71) Applicant: KAKAO CORP., Jeju-si (KR)

(72) Inventors: Hyeon Seon CHO, Seongnam-si (KR); Nam Hee KO, Seongnam-si (KR); Jee Min YANG, Seongnam-si (KR); Ra Sun KIM, Seongnam-si (KR)

(73) Assignee: KAKAO CORP., Jeju-si (KR)

(21) Appl. No.: 19/053,097

(22) Filed: Feb. 13, 2025

(30) Foreign Application Priority Data
Mar. 5, 2024 (KR) 10-2024-0031287

(51) Int. Cl. H04L 51/42

(52) U.S. Cl. CPC H04L 51/42

(57) ABSTRACT

Proposed is a method for displaying a combined content in a chat room by a user terminal. The method may include displaying candidate contents in a content input area, and receiving selection interactions with a plurality of contents among the candidate contents. The method may also include displaying a combined content in which the plurality of contents are combined on a chat interface, and displaying an interface related to the combined content on the chat interface.

### CROSS-REFERENCE TO RELATED APPLICATION

This application claims priority to and the benefit of Korean Patent Application No. 10-2024-0031287 filed on Mar. 5, 2024, the disclosure of which is incorporated herein by reference in its entirety.

### BACKGROUND

### Technical Field

The present disclosure relates to a method for a server and a user terminal to display a combined content by combining a plurality of contents in a messaging service.

### Description of Related Technology

Emojis, typically represented as pictorial symbols, are a unique language of expression on the Internet, including various pictures, images, and specific characters, rather than text-based messages sent on computers.

### SUMMARY

One aspect is a messaging service user with a feature to combine contents, thereby allowing the user to store a combination of desired contents and conveniently use the stored combination of contents.

Another aspect is to recommend a content appropriate to a text input by a messaging service user and provide any other contents combinable with a content input by the user, thereby enabling easy combination of contents to make up a combined content.

Another aspect is a method for displaying a combined content in a messaging service by a user terminal that includes: displaying candidate contents in a content input area; receiving selection interactions with a plurality of contents among the candidate contents; displaying a combined content in which the plurality of contents are combined on a chat interface; and displaying an interface related to the combined content on the chat interface.

In displaying the interface related to the combined content, the user terminal may display the interface related to the combined content in a content input area included in the chat interface.

The method may further include displaying the combined content on the chat interface in response to an interaction with the interface related to the combined content.

Displaying the combined content on the chat interface in response to an interaction with the interface related to the combined content may include: displaying the combined content in an input window of the chat interface in response to the interaction with the interface related to the combined content; and displaying the combined content in a chat window of the chat interface in response to receiving a transmission interaction regarding the input window.

Displaying the combined content may include: displaying the combined content in the input window of the chat interface when the plurality of contents satisfy the predetermined combination condition; and displaying the combined content in the chat window of the chat interface when a transmission interaction regarding the input window is received.

In displaying the combined content, the user terminal may display the combined content when the plurality of contents satisfy a predetermined combination condition.

Receiving the selection interaction may include: receiving a selection interaction with a first content that is at least one of the candidate contents; and displaying recommendation information on a second content satisfying the combination condition related to the first content.

In displaying the combined content, the combined content may be displayed on the chat interface in a different manner from other contents that do not satisfy the combination condition.

The method may further include: obtaining a request to designate the plurality of contents as a custom combined content when the plurality of contents do not satisfy the combination condition; and displaying an interface related to the custom combined content on the chat interface.

The interface related to the combined content may be displayed as either the combined content or any one of the plurality of contents.

The method may further include: further comprising: in response to an interaction with the interface related to the combined content, displaying the combined content together with a related content in the content input area; receiving a selection interaction with any one of the combined content and the related content; and displaying the any one of the combined content and the related content on the chat interface.

The related content may be a content including at least some of the plurality of contents that make up the combined content.

In displaying the combined content, the combined content may be displayed on the chat interface in a manner that is dependent on at least one of a size, a length, and a count of individual contents that make up the combined content.

Displaying the interface related to the combined content may include: obtaining an input of a text related to the combined content through an input window of the chat interface; and in response to the input of the text, displaying the interface related to the combined content in the content input area.

Displaying the interface related to the combined content may include displaying the interface related to the combined content in a content input area of a different chat interface from the chat interface.

In displaying the interface related to the combined content, the interface related to the combined content may be displayed as at least one of the user's recently used contents and favorite contents.

The candidate contents may include at least one of first-type contents combinable with each other and second-type contents not combinable with each other, the content input area may include at least one of an interface capable of displaying the first-type contents and an interface capable of displaying the second-type contents, and the interface capable of displaying the first-type contents and the interface capable of displaying the second-type contents may be displayed separately from each other.

Another aspect is a user terminal displaying a combined content in a messaging service that includes a memory storing instructions and a processor configured to execute the instructions to: display candidate contents in a content input area; receive selection interactions with a plurality of contents among the candidate contents; display a combined content in which the plurality of contents are combined on the chat interface; and display an interface related to the combined content on the chat interface.

Another aspect is a method for providing a combined content by a server in a messaging service that includes: providing candidate contents to a user terminal through a content input area; receiving a transmission request for a combined content, in which a plurality of contents are combined among the candidate contents, from the user terminal; providing a message comprising the combined content to a chat interface; and providing an interface related to the combined content to the user terminal.

Receiving the transmission request for the combined content may include: receiving from the user terminal a request to combine a first content input by a user with any content satisfying a predetermined combination condition, the first content being at least one of the candidate contents; providing the user terminal with an automatically combined content in which the first content and at least one content satisfying the combination condition; and receiving a transmission request for the automatically combined content from the user terminal.

Receiving the transmission request for the combined content may include: receiving from the user terminal a request to randomly recommend at least one combined content; providing the at least one randomly recommended combined content to the user terminal; and receiving a transmission request for the at least one randomly recommended combined content from the user terminal.

Another aspect is a server providing a combined content in a messaging service that includes a memory storing instructions and a processor configured to execute the instructions to: provide candidate contents to a user terminal through a content input area; receive from the user terminal a transmission request for a combined content in which a plurality of contents are combined among the candidate contents; provide a message comprising the combined content to a chat interface; and provide an interface related to the combined content to the user terminal.

### BRIEF DESCRIPTION OF THE DRAWINGS

FIG. 1 is a diagram illustrating an example of a network environment according to one embodiment of the present disclosure.

FIG. 2 is a flowchart for explaining a method in which a user terminal displays a combined content through a chat room according to one embodiment of the present disclosure.

FIGS. 3 to 12 illustrate example screens in a process in which a user terminal displays a combined content through a chat window according to one embodiment of the present disclosure.

FIG. 13 is a flowchart for explaining a method in which a server provides a combined content to a user terminal according to one embodiment of the present disclosure.

FIG. 14 is an example screen in which a server provides a combined content to an input window of a chat room in response to a request from a user terminal according to one embodiment of the present disclosure.

### DETAILED DESCRIPTION

The emojis are more effective than text in expressing emotions and moods. However, emojis offered by messaging services are typically presented in a simple list format, which can be inconvenient because users must scroll through pages to select a desired one. In addition, the users can use only the types of emojis provided by the messaging services, making it cumbersome to find an emoji that appropriately conveys each user's desired expression or emotion.

Accordingly, there is a growing demand for more user-friendly emoji or emoticon features, such as enabling the users to connect or combine emojis and save the resulting combinations to better express the user's emotions.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments of the present disclosure.

It will be understood that although the terms first, second, etc. may be used herein to describe various elements, these elements should not be limited by these terms. These terms are generally only used to distinguish one element from another.

As used herein, the singular forms “a”, “an,” and “the” are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the accompanying drawings.

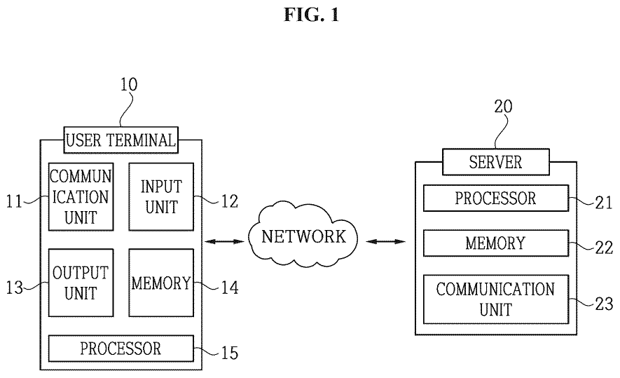

FIG. 1 is a diagram illustrating an example of a network environment according to one embodiment of the present disclosure.

A network environment according to one embodiment of the present disclosure illustrated in FIG. 1 may include a user terminal 10 and a server 20. The user terminal 10 may correspond to at least one user terminal connected to the server 20 over a network.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

The user terminal 10 may be a terminal that a user uses by logging in with an account registered to a messaging service provided by the server 20.

The user terminal 10 may include a communication unit 11, an input unit 12, an output unit 13, a memory 14, and a processor 15.

The communication unit 11 may communicate with a server 20 or another terminal in a wired/wireless manner.

The input unit 12 may receive various information through the user's manipulation and input actions. The input unit 12 may be a touch screen module, keyboard, mouse, button, camera, stylus, microphone, etc.

The user terminal 10 may receive a user's interaction through the input unit 12. The interaction refers to the act of the user operating the input unit to enter information reflecting the user's selection or intention into a user terminal. For example, the interaction may include touching on a touchscreen, clicking with a mouse, typing on a keyboard, providing voice input through a microphone, capturing an image using a camera, recognizing movements through a motion sensor, and the like.

The output section 13 may output various information. The output unit 13 may be a display device, a speaker, a vibration generator, a tactile generator, etc. In some cases, the output unit 13 may be devices (e.g., Bluetooth earphones) respectively connected to the user terminal 20 through wired or wireless communication (e.g., short-range radio communication such as Bluetooth) to receive and output signals.

The memory 14 functions as a storage medium and may store a plurality of application programs running on the user terminal 10, as well as data and instructions for operating the user terminal 10. The memory 14 may be provided in the form of any of various hardware storage devices such as an ROM, an RAM, a flash drive, a hard drive, etc. or may be provided in the form of web storage.

In one embodiment, the memory 14 may store an application related to a messaging service.

The processor 15 may control the overall operation of the communication unit 11, the input unit 12, the output unit 13, and the memory 14 to run the application related to the application related to a messaging service.

In the present disclosure, the user terminal 10 may display candidate contents in a content input area and receive interactions to select a plurality of contents among the candidate contents. The user terminal 10 may display a combined content, in which a plurality of contents are combined, on the chat interface, and display an interface related to the combined content on the chat interface.

Here, a content may be multimedia information that can be included and displayed in a message of a chat interface (hereinafter, it is assumed that the chat interface is a chat room). For example, a content may be a text, emoji, emoticon, graphic, sticker, character image, or dynamic image.

Here, a candidate content refers to at least one content that is provided for a user to select to enter as a message in a chat room. The user terminal 10 may display candidate contents at the user's request and provide an interface that allows the user to select at least one of the displayed candidate contents and input the selected candidate content into a message. In some cases, at least one content included in the candidate contents is displayed on the user terminal 10 on a single screen, on screens connected via scrolling, or on screens connected through consecutive pages, so that the user can easily view and select the at least one contents.

The candidate contents may refer to a set of contents that include a plurality of contents related to a predetermined criterion. For example, the candidate contents may refer to a set of contents that include at least one content related to a specific topic, subject, keyword, character, theme, or creator. In some cases, the candidate contents may be related to the user's content usage history. For example, the candidate contents may be the user's recently used contents or favorite contents.

Here, the content input area refers to an area that displays an interface where the user can input a content to be included in a chat message. The content input area may be displayed in a partial area of the chat room. Specifically, the content input area may be displayed so as to overlap a portion of a message window in which chat messages are displayed in the chat room. In some cases, the content input area may include a keyboard display area and an input window area where an input content is displayed. The content input area may include a combined content, which a plurality of contents satisfying a predetermined combination condition are combined.

Here, the combination condition refers to a condition on whether a plurality of contents selected by the user are combinable with each other. Content satisfying the combination condition may be combined with each other and displayed as a single combined content. The combination condition may be determined in advance by an operator of the server 20 or messaging service. As an example, the combination condition may be a case where the plurality of contents fall into the same category and the connected portions therebetween are continuous. The server 20 may provide guide information on contents combinable with each other among the plurality of candidate contents.

Here, a combined content refers to a content in which a plurality of contents are combined. A plurality of contents that constitute the combined content may satisfy the combination conditions described above. The combined content may be treated and managed as a single content. For example, a combined content used by a user may be registered as a single content in a Recently Used tab, a Favorites tab, or the like. Additionally, the user may save frequently used or popular combined contents in the Recently Used tab, the Favorites tab, or the like.

Here, the interface related to the combined content refers to an interface for a feature of re-inputting a combined content. The user may easily use a combined content through the interface related to the combined content, without having to re-select a plurality of contents that make up combined content.

The combined content may, in some cases, include a custom combined content. The custom combined content refers to a combined content that is specified by a separate request from a user, although the individual contents do not satisfy a combination condition.

The server 20 may be implemented as a computer device or a plurality of computer devices that provide commands, codes, files, content, services, etc. The server 20 may be a server 20 capable of transmitting and receiving information through communication with the user terminal 10 over a network.

The server 20 may include a processor 21, a memory 22, and a communication unit 23.

The processor 21 controls the overall operation of the memory 22 and the communication unit 23 to provide a messaging service to the user terminal 10. The messaging service provides a conversation (chatting) feature through instant messages between user terminals 10.

The memory 22 functions as a storage medium and may store a number of application programs running on the server 10, and data and commands for operation of the server 20. In one embodiment, the memory 22 may store an application program that provides a messaging service.

This memory 22 may be provided in the form of any of various hardware storage devices such as a ROM, a RAM, a flash drive, a hard drive, etc. or may be provided in the form of web storage.

The communication unit 23 may communicate with the user terminal 10 in a wired/wireless manner over a network.

The server 20 according to one embodiment of the present disclosure may provide a messaging service to the user terminal 10. Specifically, the server 20 provides a chat room where users can send and receive messages between each other, as a messaging service.

The messaging service allow each user to participate in a plurality of chat rooms, each of which is categorized by chat partner, subject, and the like. Messages sent or received by a user are tied to a chat room and may be displayed in a chat window of the chat room.

In the present disclosure, the server 20 may provide candidate contents to the user terminal 10 through a content input area, and may receive a transmission request for a combined content, in which a plurality of contents are combined among the candidate contents, from the user terminal 10. The server 20 may provide a message including the combined content to the chat interface and provide an interface related to the combined content to the user terminal 10.

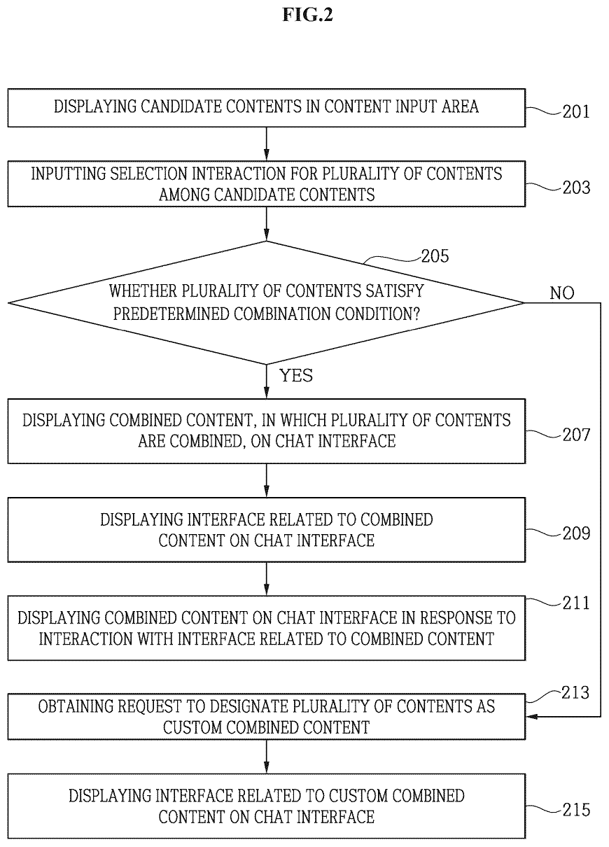

Hereinafter, a method in which a user terminal 10 displays a combined content through a chat interface according to one embodiment of the present disclosure will be described with reference to FIGS. 2 to 12.

FIG. 2 is a flowchart for explaining a method in which the user terminal 10 displays a combined content through a chat interface according to one embodiment of the present disclosure.

In operation 201, the user terminal 10 may display candidate contents in a content input area.

The user terminal 10 may display the candidate contents on a chat interface (hereinafter, the chat interface is assumed to be a chat room and explained). Specifically, the user terminal 10 may display the candidate contents in the content input area of the chat room. Here, the candidate contents may be determined by a user's request. A user may request display of candidate contents by entering a keyword, or by designate a set of contents the user possesses or subscribes to.

The candidate contents may refer to a set of contents that include a plurality of contents related to a predetermined criterion. For example, the candidate contents may refer to a set of contents that include at least one content related to a specific topic, subject, keyword, character, theme, or creator. In some cases, the candidate contents may be related to the user's content usage history. For example, the candidate contents may be the user's recently used contents or favorite contents.

The content input area may include a tab area where the user is able to request a specific candidate content. The tab area may include a Recently Used tab, a Favorites tab, and a tab for a specific topic, subject, or the like.

When the user terminal 10 receives a selection interaction with any one tab included in the tab area from the user, the user terminal 10 may display candidate contents related to the tab selected by the user in the content input area.

In operation 203, the user terminal 10 may receive selection interactions with a plurality of contents among the candidate contents from the user.

The user terminal 10 may display the candidate content in the content input area. The user may perform an input to select a plurality of contents from among the candidate contents. The candidate contents may be individual contents combinable with each other to make up a combined content.

When the user terminal 10 receives a selection interaction with a specific content among the candidate contents from the user, the user terminal 10 may display any contents combinable with the specific content. Specifically, when the user terminal 10 receives a selection interaction with at least one of the candidate contents, the user terminal 10 may display recommendation information on a second content that satisfies a combination condition related to the first content. Each of the first content and the second content may be a plurality of contents.

The recommendation information may be displayed in various ways. As an example, the recommended information may be displayed with priority over the second content in the content input area. For example, if the user selects and inputs a “cat head” content and a “cat body” content, the user terminal 10 may display a “cat tail” content as a recommended content in the content input area, with priority over other contents.

As another example, if the user selects and inputs a “cat head” content and a “cat body” content, the user terminal 10 may automatically add a “cat tail” content to complete the combined content, without a separate input from the user.

In some cases, there may be a plurality of second contents combinable with the first content. In this case, the recommendation information may be displayed in various ways. For example, the user terminal 10 may recommend one of the plurality of second contents based on the popularity of the contents or the user's preference, with priority over other second contents.

The selection interactions for the plurality of contents may include a plurality of selection interactions for a single content. Specifically, the user terminal 10 may only receive a plurality of selection inputs for one content. In this case, if a plurality of contents satisfy a combination condition, the user terminal 10 may display a combined content in which the plurality of contents are combined.

The user terminal 10 may receive a plurality of selection interactions for one content among the candidate contents. For example, the user terminal 10 may obtain a selection interaction with the “cat body” content five times after obtaining a selection interaction with the “cat head” content. In this case, the size and length of the combined content may be modified due to the plurality of selection interactions.

In operation 205, the user terminal 10 may determine whether the plurality of contents satisfy a predetermined combination condition.

When it is determined that the combination condition is satisfied in operation 205, operation 207 may be performed subsequently, and when it is not determined that the combination condition is satisfied, operation 213 may be performed subsequently.

The predetermined combination condition refer to whether the plurality of contents selected by the user are contents combinable with each other. The combination condition may be set to various conditions.

As an example, the combination condition may be determined in advance by the operator of the server 20 or messaging service. Specifically, the combination condition may be a case where the plurality of contents fall into the same category and the connected portions therebetween are continuous. In this case, the user may only combine contents allowed by the server 20. The server 20 may provide guide information on contents combinable with each other among the plurality of candidate contents.

As another example, the combination condition may be determined based on a type of a combined content. Specifically, the combined content may be a connectively combined content, which is of a type to connect each content. The connectively combined content may be a combination of emojis, such as “cat head”, “cat body”, and “cat tail”. In such cases, the combination condition may be a case where the connective portion of a corresponding content is continuous.

Additionally, combined content may be a decoratively combined content in which a specific content is decorated with any other contents. Specifically, the decoratively combined content may be a combination of emojis, in which a “birthday cake” emoji is further decorated with emojis such as “ribbon” and “candle”. In such cases, the combination condition may be whether or not a corresponding content is included in the decoration tab.

When the plurality of contents satisfy a combination condition, the user terminal 10 may display information related to satisfaction of the combination condition. The information related to satisfaction of the combination condition may be displayed in various ways. For example, the information related to satisfaction of the combination condition may be displayed through a combination of the plurality of contents with changes in size, length, and composition, or via a separate display entity related to satisfaction of combination conditions in a chat room.

In operation 207, if the plurality of contents satisfy the predetermined combination condition, the user terminal 10 may display a combined content in which the plurality of contents are combined on the chat interface.

The user terminal 10 may display the combined content in a chat room in various ways. Specifically, the user terminal 10 may display the combined content in an input window or chat window of the chat room.

As an example, operation 207 of displaying the combined content may include operation 207a of displaying the combined content in the input window of the chat room and operation 207b of displaying the combined content in the chat window of the chat room.

In operation 207a, the user terminal 10 may display the combined content in the input window of the chat room.

The user terminal 10 may display the combined content including the plurality of contents selected by the user in the input window of the chat room. Specifically, the user terminal 10 may display the combined content in the input window of the chat room when the contents selected by the user satisfies the combination condition.

In some cases, the user terminal 10 may automatically complete the combined content when a selection interaction with at least one component of the combined content is input by the user. Specifically, the user terminal 10 may input a selection interaction with at least one component of the combined content, and then automatically add a content to be combined at the end of the combined content to complete the combined content even without a separate selection interaction from the user.

The user terminal 10 may display any contents satisfying the combination condition and any contents not satisfying the combination condition in the input window of the chat room in different ways. For example, as for the contents satisfying the combination condition, the user terminal 10 may display a combination of a plurality of contents in the input window. On the other hand, as for the contents not satisfying the combination condition, the user terminal 10 may individually display a plurality of uncombined contents in the input window.

The user terminal 10 may receive a transmission interaction regarding the input window. When the user terminal 10 receives a transmission interaction, the user terminal 10 may display a combined content in the chat window of the chat room.

In operation 207b, the user terminal 10 may display the combined content in the chat window of the chat room.

The user terminal 10 may display contents satisfying the combination condition and content not satisfying the combination condition in the chat window of the chat room in different ways. Specifically, when a plurality of contents satisfy the combination condition, the user terminal 10 may display a combined content in which the plurality of contents are combined. However, when a plurality of contents do not satisfy the combination condition, the user terminal 10 may display each of a plurality of uncombined contents.

The user terminal 10 may display different combinations of contents in the chat window of the chat room according to a predetermined method related to a plurality of contents. Specifically, the predetermined condition related to the plurality of contents may be related to a count of selected contents. As an example, if seven or more contents are selected, the user terminal 10 may display a combined content in a small speech bubble. However, if less than seven contents are selected, the user terminal 10 may only display a combined content without a speech bubble.

The user terminal 10 may display a combined content together with a text. In this case, the user terminal 10 may display a text within a speech bubble and a combined content below or above the speech bubble. In some cases, the user terminal 10 may display the text and the combined content simultaneously within the speech bubble.

In the above, it has been described that operation 207 includes operations 207a and 207b, but the user terminal 10 is not limited thereto and may display a combined content, in which a plurality of contents are combined, in a chat room in various ways.

In operation 209, the user terminal 10 may display an interface related to the combined content on the chat interface.

The user terminal 10 may display an interface related to the combined content in a content input area that is one specific area of the chat interface. The interface related to the combined content may be displayed in relation to a specific tab in the content input area. The content input area may include at least one tab. A user may select the specific tab in the content input area, and the user terminal 10 may display any contents included in the selected tab in the content input area. For example, each tab in the content input area may include a Recently Used tab, a Favorites tab, or tabs for specific topics or subjects. In this case, the combined content may be displayed through the Recently Used tab or the Favorites tab.

Additionally, the combined content may be displayed through a tab for a related topic. However, the combined content may not be displayed in tabs for different topics. For example, if the user terminal 10 displays a combined content for the Cat tab, the user terminal 10 may display an interface related to the combined content in a content input area of the Cat tab.

The interfaces related to the combined content may be displayed in various ways. As an example, the interface related to the combined content may be displayed in the form of the combined content image in which individual candidate contents are combined. Specifically, if a combined content is a combination of “cat head”, “cat body”, and “cat tail” contents, an interface related to the combined content may be displayed in the form of a cat image in which the “cat head”, “cat body”, and “cat tail” contents are combined.

As another example, an interface related to a combined content may be displayed as any one of a plurality of contents that make up the combined content. In this case, any one of the plurality of contents that make up the combined content may be a first content that is a content combined at the very beginning of the combined content. For example, if a combined content is a combination of “cat head”, “cat body”, and “cat tail” contents, an interface related to the combined content may be displayed as the “cat head” content which is the first content.

As another example, an interface related to a combined content may be displayed as a representative content of the combined content. Specifically, if a combined content is a combination of a “cake” content and “ribbon” and “candle” contents decorating the “cake” content, an interface related to the combined content may be displayed as the “cake” content.

The user terminal 10 may display a combined content together with a related content in the content input area in response to an interaction with an interface related to the combined content. Here, the related content may be a content that includes at least some of a plurality of contents that make up the combined content. For example, if the combined content is a combination of “cat head”, “cat body”, and “cat tail” contents, the related content of the combined content may be another combined content that includes the “cat head” content.

The user terminal 10 may receive a selection interaction with any one of the combined content and the related content. When the user terminal 10 receives the selection interaction, the user terminal 10 may display any one of the combined content and the related content in the input window. When the user terminal 10 receives a transmission interaction regarding an input window, the user terminal 10 may display any one of the combined content and the related content in the chat window.

An interface related to the combined content may be related to a user's usage history information for the combined content. For example, if the user terminal 10 recently sent a “long cat” combined content to the chat window, the interface related to the combined content may include the “long cat” combined content.

The user terminal 10 may display an interface related to a combined content in response to a text input in the content input area. Specifically, the user terminal 10 may obtain an input of a text related to the combined content through the input window of the chat room. When the user terminal 10 obtains a text input, the user terminal 10 may display an interface related to a combined content corresponding to the text in the content input area. For example, the user terminal 10 may obtain an input “cat” through the input window of the chat room. In this case, the user terminal 10 may display an interface related to a combined content corresponding to a cat.

The interface related to the combined content may be displayed as at least one of the user's recently used contents and favorite contents. For example, if a combined content that the user recently used is a “cat” combined content, an interface related to the combined content may be displayed as the “cat” combined content. Additionally, if a content saved by the user in the Favorites tab is a “puppy” combined content, an interface related to the combined content may be displayed as the “puppy” combined content.

The user terminal 10 may display interfaces related to a plurality of combined contents. Specifically, when the user terminal 10 displays a “puppy” combined content and a “cat” combined content in the input window of the chat room, the user terminal 10 may display an interface related to the “puppy” combined content and an interface related to the “cat” combined content in the Recently Used tab. In some cases, the user terminal 10 may display only interfaces related to a plurality of combined contents in a content input area of a specific tab area.

In operation 211, in response to an interaction with an interface related to a combined content, the user terminal 10 may display the combined content on the chat interface.

The user terminal 10 may display the combined content in a chat room in various ways. Specifically, the user terminal 10 may display the combined content in an input window or chat window of the chat room.

For example, operation 211 of displaying a combined content in response to an interaction with an interface related to the combined content may include operation 211a of displaying the combined content in the input window of the chat room and operation 211b of displaying the combined content in the chat window of the chat room.

In operation 211a, the user terminal 10 may display the combined content in the input window of the chat room.

When the user terminal 10 receives an interaction with the interface related to the combined content, the user terminal 10 may display the combined content in the input window of the chat room. The interaction may be either a selection input or a long tap to the interface related to the combined content. In this case, a user may easily use the combined content through the interface related to the combined content, without having to re-select a plurality of contents that make up the combined content.

For example, when the user terminal 10 inputs a “cat” combined content in which “cat head”, “cat body”, and “cat tail” contents are combined, an interface related to the “cat” combined content may be displayed in the content input area. In this case, the user terminal 10 may display the “cat” combined content again in the input window by receiving a selection interaction with the interface related to the combined content, instead of receiving a selection interaction with each of the “cat head”, “cat body”, and “cat tail” contents to display the same “cat” combined content again in the input window.

In operation 211b, the user terminal 10 may display the combined content in the chat window of the chat room.

When the user terminal 10 receives a transmission interaction regarding the input window, the user terminal 10 may display the combined content in the chat window of the chat room.

The user terminal 10 may display the interface related to the combined content in a content input area of a different chat room from the chat room displaying the combined content. Specifically, when the user terminal 10 displays a combined content in a chat room, the user terminal 10 may store the combined content displayed in the chat room. In this case, when the user terminal 10 displays a content input area of a different chat room, the user terminal 10 may display an interface related to the combined content in the content input area of the different chat room.

In the above, it has been described that operation 211 includes operations 211a and 211b, but the user terminal 10 is not limited thereto and may display a combined content in a chat room in response to an interaction with an interface related to the combined content in various ways.

In operation 213, if a plurality of contents do not satisfy a predetermined combination condition, the user terminal 10 may obtain a request to designate the plurality of contents as a custom combined content.

The user terminal 10 may receive selection interactions with the plurality of contents among candidate contents. If the plurality of contents, which are selected by the user, do not satisfy the combination condition, the user terminal 10 may display the plurality of contents in the input window of the chat room. When the user terminal 10 receives a transmission interaction regarding the input window, the user terminal 10 may display the plurality of contents in the chat window of the chat room.

The user terminal 10 may obtain a request to designate the plurality of contents as a custom combined content. Specifically, the user terminal 10 may obtain a request from the user to designate a plurality of contents freely selected by a user as a custom combined content even if the plurality of contents do not satisfy a combination condition.

The request to designate a plurality of contents as a custom combined content may be made in various ways. For example, the user terminal 10 may obtain a request to designate a plurality of contents as a custom combined content through a separate interface for designating a custom combined content. Specifically, a user may designate a plurality of desired contents as a custom combined content through a separate interface.

As another example, the user terminal 10 may obtain a request to designate a plurality of contents as a custom combined content through a chat room. Specifically, the user terminal 10 may display a plurality of contents not satisfying a combination conditions in a chat room. A user may apply a long-tap interaction to each of the plurality of contents displayed in the chat room to make a request that designate the plurality of contents as a custom combined content.

In operation 215, the user terminal 10 may display an interface related to a custom combined content on the chat interface.

The user terminal 10 may display the interface related to the custom combined content in a content input area, which is one specific area of the chat interface. Specifically, when the user terminal 10 obtains a request to designate a plurality of contents as a custom combined content, the user terminal 10 may display the interface related to the custom combined content in the content input area.

In response to an interaction with the interface related to the custom combined content, the user terminal 10 may display the custom combined content in the input window of the chat room. When the user terminal 10 receives a transmission interaction regarding the input window, the user terminal 10 may display the custom combined content in the chat window of the chat room. In some cases, the custom combined content may be displayed in the same area as the area where the combined content is displayed.

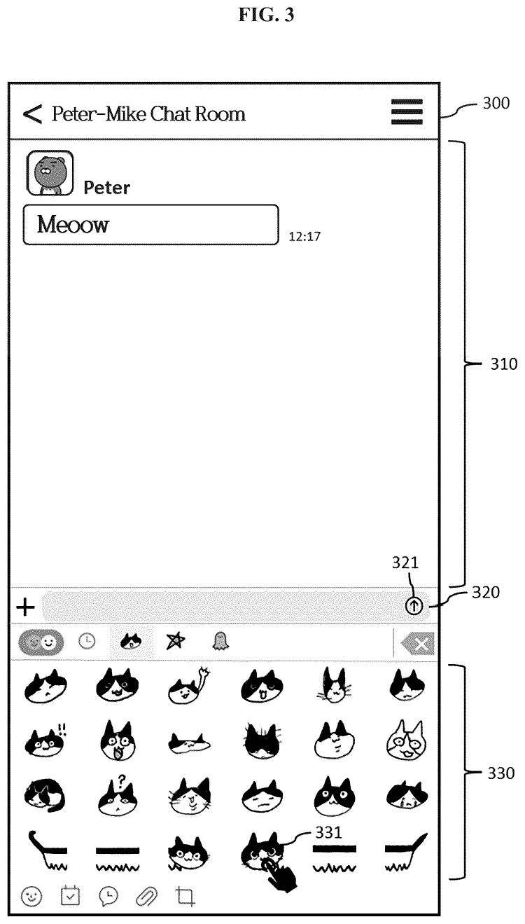

Hereinafter, a method in which the user terminal 10 displays a combined content through a chat interface according to one embodiment of the present disclosure will be described with reference to FIGS. 3 to 12.

FIG. 3 illustrates a screen in which the user terminal 10 displays a candidate content 331 in a content input area 330.

Referring to FIG. 3, a chat room 300 may display a chat window 310 of a chat room, an input window 320 of the chat room, and the content input area 330. The content input area 330 may include a candidate content 331.

The user terminal 10 may display text, a content, and a group content input by the user in the input window 320 of the chat room 300. When the user terminal 10 receives from the user a transmission interaction with a transmission interface 321, the user terminal 10 may display the text, content, and group content displayed in the input window 320 in the chat window 310.

The user terminal 10 may display candidate contents in the content input area 330. The user terminal 10 may obtain a selection input for one candidate content 331 among the candidate contents. For example, the user terminal 10 may obtain a selection input for a “cat head” content 331.

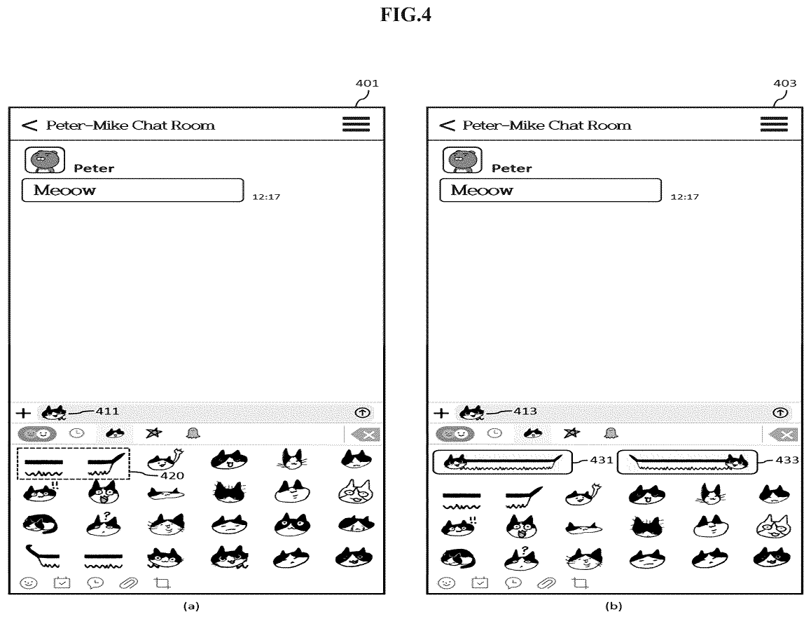

FIG. 4 illustrates a screen 400 in which, when the user terminal 10 receives a selection interaction with a first content, the user terminal 10 displays recommendation information on a second content that satisfies a combination condition.

The screen of FIG. 4 may be displayed in response to a selection interaction with one candidate content 331 among the candidate contents in FIG. 3.

In FIG. 4, (a) illustrates a screen 401 that displays recommendation information on individual contents.

In FIG. 4, (b) illustrates a screen 403 that displays recommendation information on a combined content.

Referring to (a) of FIG. 4, the order of candidate contents displayed in the content input area is different from the order of candidate contents included in the content input area 330 of FIG. 3, and a plurality of candidate contents 420 that can be connected to a first content 411 may be displayed with priority over other candidate contents.

Specifically, when the user terminal 10 receives a selection interaction with the first content 411 from the user, the user terminal 10 may display at least one second content 420 that can be connected to the first content 411 in the content input area with priority over other candidate content.

For example, when the user terminal 10 receives from the user a selection interaction with a “cat head” emoji, the user terminal 10 may display “cat body” and “cat tail” emojis 420 that can be connected to the “cat head” emoji, with priority over other candidate contents.

Although not shown in the drawing, the user terminal 10 may display recommended information by showing a combination of a first content and a second content as a preview in the input window. In such a preview, a combined content may be displayed differently in color, shade, or the like from contents selected by the user.

Referring to (b) of FIG. 4, interfaces 431 and 433 related to a combined content including a first content 413 in the content input area may be displayed with priority over other candidate contents.

Specifically, when the user terminal 10 receives a selection interaction with the first content 413 from the user, the user terminal 10 may display the interfaces 431 and 433 related to at least one combined content including the first content 413 in the content input area with priority over other candidate content.

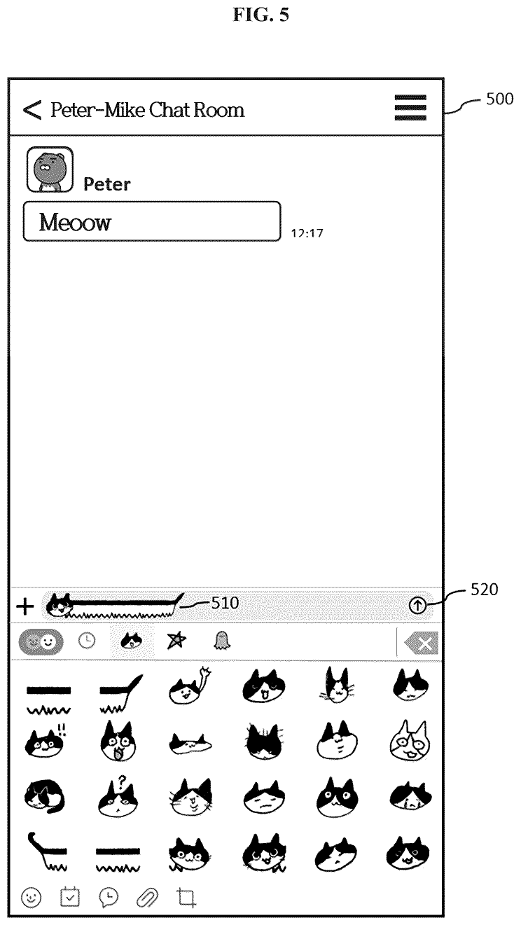

FIG. 5 illustrates a screen in which the user terminal 10 displays combined content 510 including first and second contents in an input window of a chat room 500.

The screen of FIG. 5 may be displayed in response to a selection interaction with a candidate content 420 that can be connected to the first content in FIG. 4.

Referring to FIG. 5, the user terminal 10 may display a combined content 510 in the input window of the chat room 500. The combined content 510 may include the candidate content 331 of FIG. 3 and the candidate contents 420 of FIG. 4.

The user terminal 10 may display the combined content 510 in the input window in various ways. As an example, the user terminal 10 may display the combined content 510 by receiving interactions to select a plurality of contents from the user. Specifically, the user terminal 10 may receive interactions to select a plurality of contents among candidate contents from the user. If the plurality of contents satisfy a predetermined condition, the user terminal 10 may display the combined content 510, in which the plurality of contents are combined, in the input window of the chat room 500.

As another example, the user terminal 10 may display the combined content 510 by an auto-complete feature. Specifically, the user terminal 10 may obtain an input for a first content from the user. The user terminal 10 may display the combined content 510 by automatically combining a second content that satisfies a predetermined combination condition related to the first content. Here, the second content may be plural or may be an intermediate content that is combined in the middle rather than at the end of a combined content.

In some cases, if the user terminal 10 receives a selection interaction with the first content and the intermediate content from the user while receiving no selection interaction with a content to be combined at the end of a combined content 510, the user terminal 10 may automatically combine the ending content to complete and display the combined content 510.

When the user terminal 10 receives an interaction with a transmission interface 520, the user terminal 10 may display the combined content 510 in the chat window.

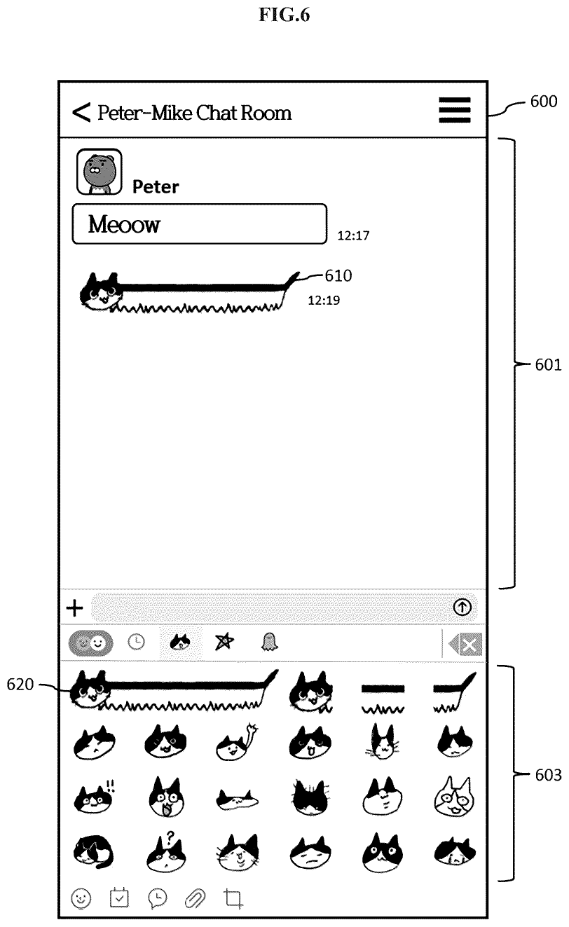

FIG. 6 illustrates a screen in which the user terminal 10 displays a combined content 610 including first and second contents in a chat window 601 of a chat room 600.

The screen of FIG. 6 may be displayed in response to an interaction with the transmission interface 520 in FIG. 5.

Referring to FIG. 6, the user terminal 10 may display the combined content 610 in the chat window 601 of the chat room 600. Specifically, the user terminal 10 may display only the combined content 610 in the chat window 601, without including the combined content 610 within a speech bubble.

The user terminal 10 may display an interface 620 related to the combined content 610 in the content input area 603. Specifically, when the user terminal 10 displays the combined content 610 in the chat window 601, the user terminal 10 may display the interface 620 related to the combined content 610 in the content input area 603. In this case, the interface 620 related to the combined content 610 may be displayed with priority over other candidate contents.

The interface 620 related to the combined content 610 may be displayed differently depending on a count of individual contents combined as the combined content 610. For example, if a count of individual contents combined as the combined content 610 is three, the interface 620 related to the combined content 610 may be displayed with a total length (or size) of the three individual contents.

When the user terminal 10 receives a selection interaction with the interface 620 related to the combined content 610, the combined content 610 may be displayed in the input window of the chat room.

Although not shown in the drawing, the combined content 610 may have an animation effect. For example, a “cat” combined content 610 may have an animation effect such as the cat's legs moving or the cat walking around within the chat window.

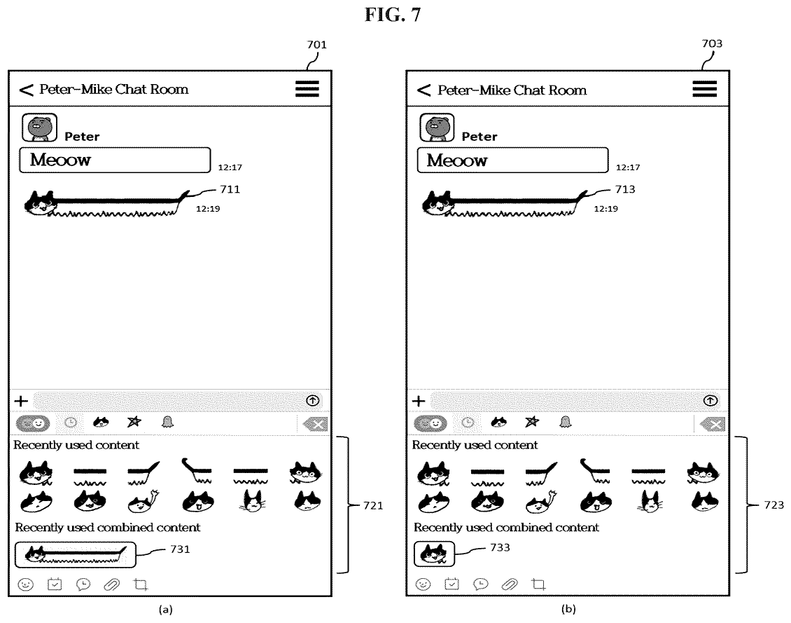

FIG. 7 illustrates a screen in which the user terminal 10 displays an interface 731 or 733 related to a combined content in a content input area 721 or 723 of a chat room 701 or 703.

The screen of FIG. 7 may be displayed in response to an interaction with a Recently Used tab among the tabs in the content input area 603 in FIG. 6.

In FIG. 7, (a) illustrates a screen where the user terminal 10 according to one embodiment of the present disclosure displays the interface 731 related to a combined content as the combined content itself.

In FIG. 7, (b) illustrates a screen where the user terminal 10 according to one embodiment of the present disclosure displays the interface 733 related to a combined content as one of a plurality of contents that make up the combined content.

Referring to (a) of FIG. 7, when the user terminal 10 displays a combined content 711 in a chat window, the user terminal 10 may display the interface 731 related to the combined content 711 in the content input area 721.

The interface 731 related to the combined content 711 may be displayed in various ways. As an example, the interface 731 related to the combined content 711 may be displayed as the combined content 711 intact or a reduced version of the combined content. Specifically, as illustrated in (a) of FIG. 7, the interface 731 related to the combined content 711 may be displayed as a “long cat” combined content 731 selected by a user or as a reduced version of the “long cat” combined content 731.

As another example, the interface 733 related to a combined content may be displayed as a first content that is combined at the very beginning of the combined content. Specifically, as illustrated in (b) of FIG. 7, the interface 733 related to the combined content may be displayed as a “cat head” 733 combined at the very beginning of the combined content.

As another example, an interface related to a combined content may be displayed as a representative content of the combined content. Specifically, as illustrated in (b) of FIG. 7, the interface 733 related to the combined content may be displayed as the “cat head” 733, which is the most recognizable representative content from the combined content.

When the user terminal 10 receives an interaction with the interface 731 or 733 related to a combined content, the combined content may be displayed in an input window of the chat room.

Although not shown in the drawing, a user may add, delete, move, and modify the interface related to each individual content or combined content displayed in the content input area 721 or 723. Additionally, the user may add a list that can be displayed such as “Recently Used Contents” and “Favorite Contents”.

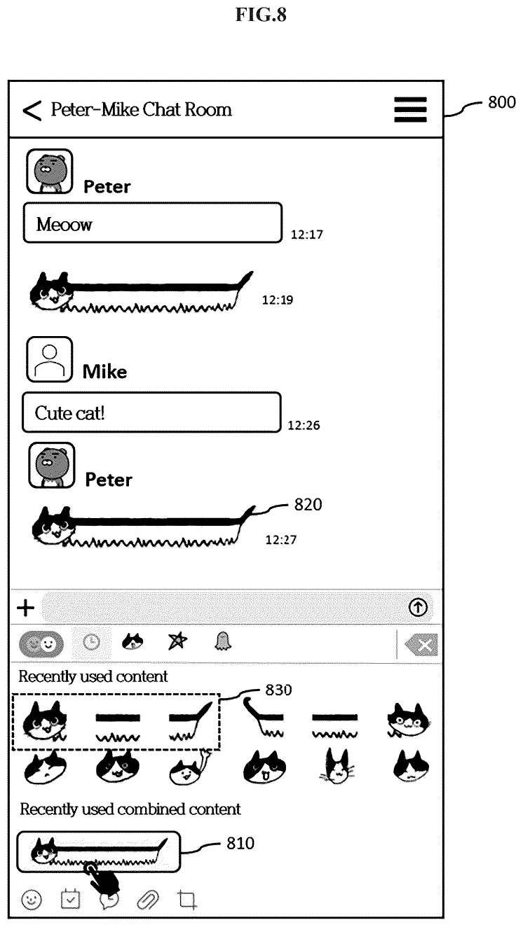

FIG. 8 illustrates a screen 800 in which the user terminal 10 re-displays a combined content 820 in a chat window according to one embodiment of the present disclosure.

The screen of FIG. 8 may be displayed in response to an interaction with the interface 731 or 733 related to a combined content in the screen (a) or (b) of FIG. 7.

Referring to FIG. 8, the user terminal 10 may display an interface 810 related to a combined content in the content input area. When the user terminal 10 receives an interaction with the interface 810 related to the combined content, the combined content may be displayed in a chat window of a chat room. When the user terminal 10 receives a transmission interaction regarding the chat window, the combined content 820 may be displayed in the chat window of the chat room.

In this case, the user may conveniently re-input the combined content by performing an interaction with the interface 810 related to the combined content, instead of re-inputting each of a plurality of contents 830.

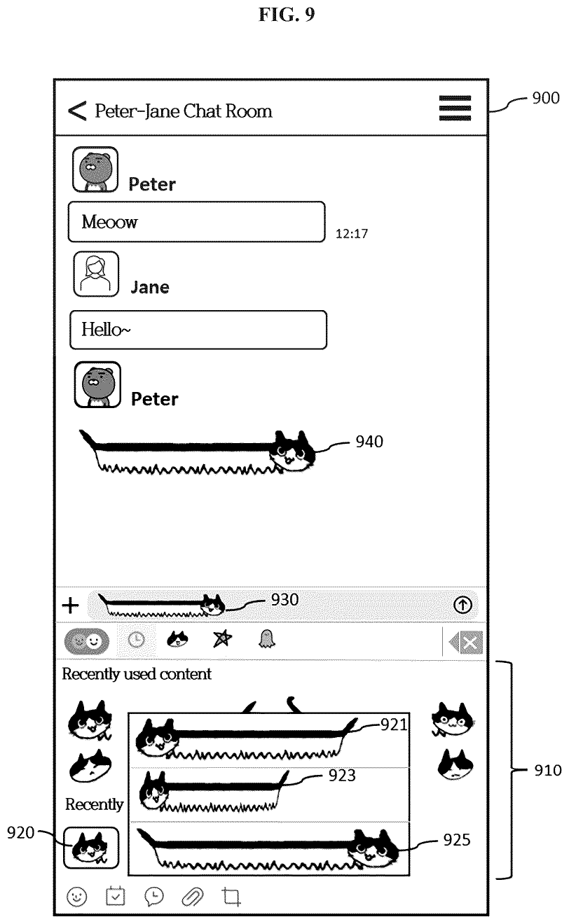

FIG. 9 illustrates a screen 900 in which the user terminal 10 displays a combined content 921 and related contents 923 and 925 in a content input area.

The screen of FIG. 9 may be displayed in response to an interaction with the interface 810 related to the combined content on the screen of FIG. 8.

Referring to FIG. 9, the user terminal 10 may display a plurality of combined contents 921, 923, and 925 in a content input area 910. Specifically, an interface related to each combined content may be displayed as at least one content 920 among the plurality of contents that make up a corresponding combined content.

The user terminal 10 may display the combined content 921 and the related contents 923 and 925 in response to the user's interaction with the interface 920 related to the combined content 921. Here, each of the related contents 923 and 925 may be a combined content that includes some contents among a plurality of contents that make up the combined content 921.

For example, the combined content 921 may include a “cat head”, a “cat body”, and a “cat tail”. In this case, each of the related contents 923 and 925 may be a combined content including the “cat head”. In addition, the related contents 923 and 925 may be displayed as contents that are different in length, direction, or composition from the combined content 921.

When the user terminal 10 receives a selection interaction with either the combined content 921 or any one of the related contents 923 and 925 from a user, the user terminal 10 may display a combined content 930 selected by the user in the input window. When the user terminal 10 receives a transmission interaction regarding the input window, a combined content 940 may be displayed on a chat window.

The user terminal 10 may display an interface related to a combined content in a content input area of a different chat room 900 from the chat room where the combined content is displayed. Specifically, the user terminal 10 may display a combined content in a specific chat room (e.g., the Peter-Mike chat room of FIG. 6) and display the content input area 910 in a different chat room (e.g., the Peter-Jane chat room of FIG. 9). In this case, in the content input area 910, the user terminal 10 may display an interface 920 related to the combined content displayed in the specific chat room (e.g., the Peter-Mike chat room of FIG. 6).

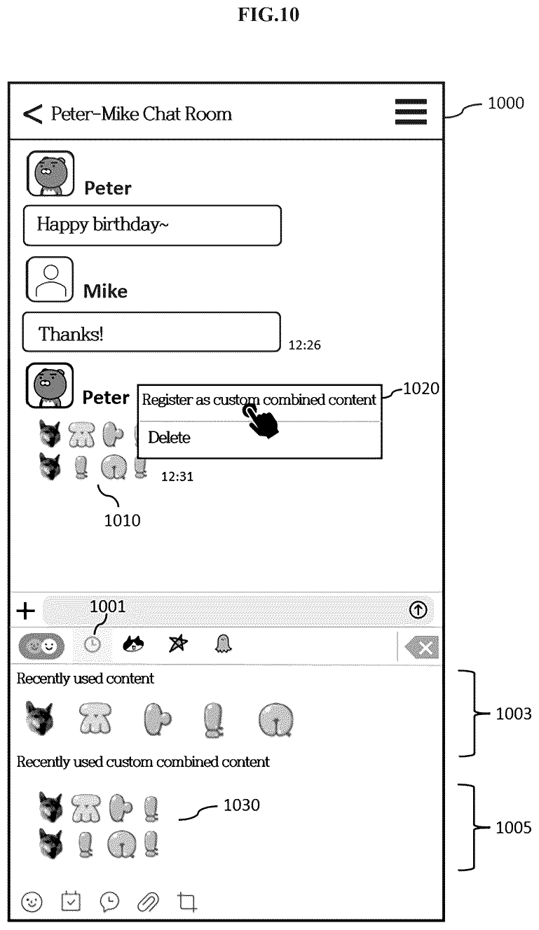

FIG. 10 illustrates a screen in which the user terminal 10 displays a custom combined content 1010 that is a combination of at least some of candidate contents.

Referring to FIG. 10, a content input area of a Recently Used tab 1001 may include an individual content input area 1003 and a combined content input area 1005.

The user terminal 10 may designate a plurality of contents not satisfying a combination condition as a combined content. Specifically, the user terminal 10 may display a plurality of contents 1010 not satisfying the combination condition in a chat window. The user terminal 10 may obtain a request 1020 from the user to designate the plurality of contents 1010 as a custom combined content. In this case, the user terminal 10 may designate the plurality of contents 1010 as a custom combined content.

When the user terminal 10 designates the plurality of contents 1010 as a custom combined content, the user terminal 10 may display an interface related to the custom combined content in the combined content input area 1005.

As illustrated in FIG. 10, when the user terminal 10 displays the plurality of contents 1010 in the chat window of the chat room, the user terminal 10 may display each individual content of the plurality of contents making up the combined content in the individual content input area 1003.

Although not shown in the drawing, the user terminal 10 may display an interface for combining contents to make up a custom combined content. Here, the interface for combining contents to make up a custom combined content may include at least some of the candidate contents. A user may designate a custom combined content by combining at least some of the candidate contents. The user may input information on the custom combined content into the user terminal 10. When the user terminal 10 obtains the information on the custom combined content, the user terminal 10 may display an interface related to the custom combined content in the content input area.

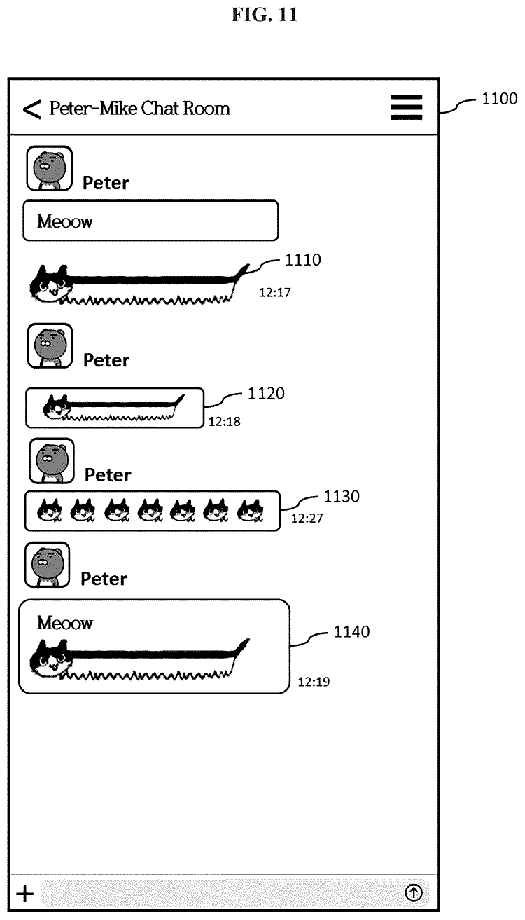

FIG. 11 illustrates a screen 1100 in which the user terminal 10 displays a plurality of contents 1110, 1120, 1130, 1140 differently according to predetermined condition.

Referring to FIG. 11, the user terminal 10 may display the combined content 1110 and individual contents 1130 without or within a speech bubble. Additionally, the user terminal 10 may display the combined content 1140 together with a text.

The user terminal 10 may display contents in various ways, as indicated by reference numerals 1110, 1120, 1130, and 1140. Specifically, the combined contents 1110 and 1120, the plurality of individual contents 1130, and the combined content 1140 including the text may be displayed in various ways.

The user terminal 10 may display the combined contents 1110 and 1120 differently according to a predetermined method. Here, the predetermined method may be associated with a count of combined contents, a count of individual contents, or the like.

Specifically, if less than seven candidate contents are selected by a user, the user terminal 10 may display only a combined content without a speech bubble, as indicated by reference numeral 1110. However, if seven or more candidate contents are selected by the user, the user terminal 10 may display a combined content in a reduced size within a speech bubble, as indicated by reference numeral 1120.

For example, if a “cat head” content, four “cat body” contents, and a “cat tail” content are input (in which case six candidate contents are input), the user terminal 10 may display a “long cat” content 1110 without a speech bubble, as shown in (a) of FIG. 10. However, if a “cat head” content, five “cat body” contents, and a “cat tail” content are input (in which case seven candidate contents are input), the user terminal 10 may display a “long cat” content 1120 within a speech bubble, as shown in (a) of FIG. 10.

The user terminal 10 may display individual contents differently according to a predetermined method. Here, the predetermined condition may be related to a count of individual contents. Specifically, when a count of individual contents is less than seven, the user terminal 10 may display the individual contents without a speech bubble. However, when there are seven or more individual contents input by the user, the user terminal 10 may display the plurality of individual contents (seven or more individual contents) within a speech bubble, as indicated by reference numeral 1130.

For example, if one “cat head” content is input, the user terminal 10 may display the “cat head” content without a speech bubble. However, if seven “cat head” contents are input, the user terminal 10 may display the “cat head” content within a speech bubble, as indicated by reference numeral 1130 in FIG. 11.

The user terminal 10 may display a combined content together with a text. The user terminal 10 may display a combined content together with a text in various ways.

As an example, the user terminal 10 may display a text within a speech bubble and a combined content below or above the speech bubble, as indicated by reference numeral 1110. Whether the combined content is to be displayed above or below the speech bubble may be determined by the order in which the combined content and the text are input. For instance, if the user inputs a combined content first into an input window of a chat room and then inputs a text later, the combined content may be positioned above a speech bubble in the chat window of the chat room. However, if the user inputs a text first into the input window of the chat room and then inputs a combined content later, the combined content may be positioned below the speech bubble in the chat window of the chat room.

As another example, the user terminal 10 may display a text and a combined content together within a speech bubble, as indicated by reference numeral 1140. Specifically, when seven or more candidate contents are selected by the user, the user terminal 10 may display a combined content in a reduced size together with the text within a speech bubble, as indicated by reference numeral 1140.

In some cases, when a text and a combined content are input together, the user terminal 10 may display the combined content in a reduced size together with the text within a speech bubble, as indicated by reference numeral 1140, even if less than seven candidate contents are selected by the user

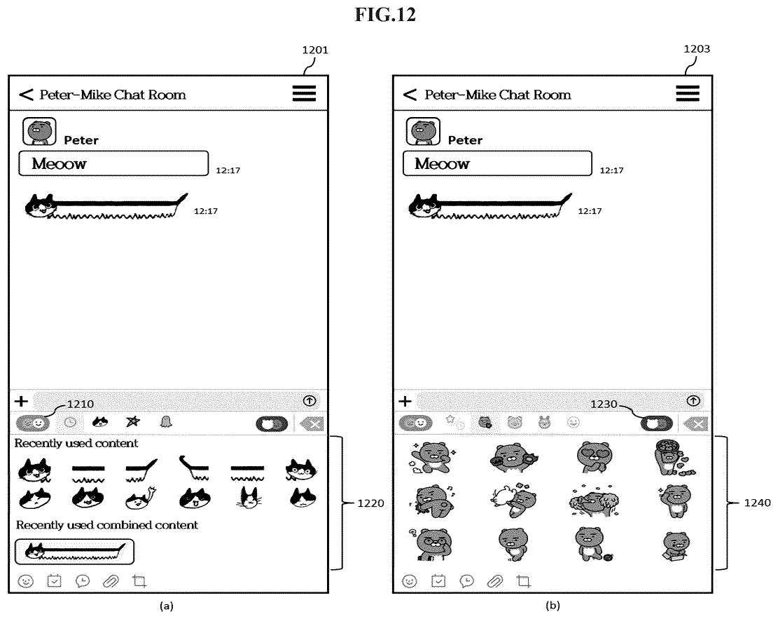

FIG. 12 illustrates a screen in which the user terminal 10 displays a first-type-content display interface 1210 and a second-type-content display interface 1230.

Referring to FIG. 12, candidate contents may include first-type contents combinable with each other and second-type contents not combinable with each other. The user terminal 10 may display the first-type-content display interface 1210, and the second-type-content display interface 1230 in a chat room.

The user terminal 10 may receive a selection interaction with an interface capable of displaying either the first-type contents or the second-type contents.

In FIG. 12, (a) illustrates a screen 1201 in which the user terminal 10 according to one embodiment of the present disclosure displays a first-type-content display interface 1210 and the first-type contents, as indicated by reference numeral 1220.

Referring to (a) of FIG. 12, the user terminal 10 may display the first-type-content display interface 1210 in a content input area 1220. When the user terminal 10 receives an interaction with the first-type-content display interface 1210 from a user, the user terminal 10 may display the first-type contents in the content input area 1220.

When the candidate contents are first-type contents, the user terminal 10 receives selection interactions for a plurality of first-type contents. Then, if the plurality of first-type contents satisfy a predetermined combination condition, the user terminal 10 may display a combined content, in which the plurality of first-type contents are combined, in a chat room.

In FIG. 12, (b) illustrates a screen 1203 in which the user terminal 10 according to one embodiment of the present disclosure displays the second-type-content display interface 1230 and the second-type contents, as indicated by reference numeral 1240.

Referring to (b) of FIG. 12, the user terminal 10 may display the second-type-content display interface 1230 in a content input area 1240. When the user terminal 10 receives an interaction with the second-type-content display interface 1230 from the user, the user terminal 10 may display the second-type contents in the content input area 1240.

As illustrated in FIG. 12, the first-type-content display interface 1210 and the second-type-content display interface 1230 may be displayed separately from each other.

Although not shown in the drawing, in some cases, a first-type-content display interface 1210 and a second-type-content display interface 1230 may be displayed in the same area. Specifically, the first-type-content display interface 1210 and the second-type-content display interface 1230 may be displayed in the same area and switchable from each other.

When the candidate contents are second-type contents, the user terminal 10 may receive selection interactions for a plurality of second-type contents and accordingly display the plurality of selected second-type contents in the chat room.

In some cases, when the user terminal 10 receives a request to designate the plurality of second-type contents as a custom combined content described above, the user terminal 10 may display the custom combined content made up by the second-type contents only.

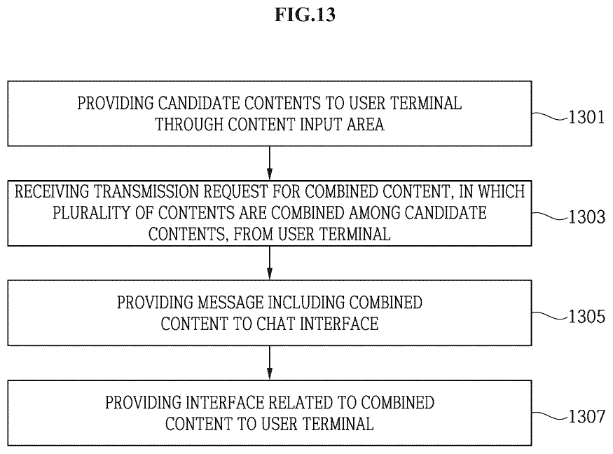

FIG. 13 is a flowchart for explaining a method in which a server 20 according to one embodiment of the present disclosure provides a combined content to a user terminal 10.

For convenience of explanation, the description of operations in FIG. 13 substantially identical to operations in FIG. 2 is replaced with a description referring to FIG. 2.

In operation 1301, the server 20 provides candidate contents to the user terminal 10 through a content input area. Since operation 1301 is substantially identical to operation 201 of FIG. 2, the description of operation 1301 is replaced with the description of operation 201 of FIG. 2.

In operation 1303, the server 20 receives from the user terminal 10 a transmission request for a combined content in which a plurality of contents are combined among the candidate contents. Since operation 1303 is similar to operation 203 of FIG. 2, any description of operation 1303 that is the same as operation 203 of FIG. 2 is replaced with the description of operation 203 of FIG. 2.

The server 20 may receive a transmission request for a combined content from the user terminal 10. Specifically, the user terminal 10 may display the combined content in an input window of a chat room. The server 20 may receive a transmission request for a combined content in response to receiving a transmission interaction regarding an input window from the user terminal 10.

The user terminal 10 may display the combined content in the input window of the chat room in various ways. As an example, the user terminal 10 may display an automatically combined content provided from the server 20 in the input window of the chat room. Specifically, the user terminal 10 may receive a selection interaction with a first content from a user. The server 20 may receive a request from the user terminal 10 to combine the first content with any contents satisfying a predetermined combination condition. When the server 20 receives such a request for combination, the server 20 may provide the user terminal 10 with an automatically combined content in which the first content and at least one content satisfying the combination condition are combined. Here, the request to combine the first content with any contents satisfying the predetermined combination condition may be made through an automatic combination interface.

For example, the user terminal 10 may receive a selection interaction with a “cat head” content from the user. When the server 20 receives an interaction with the automatic combination interface from the user terminal 10, the server 20 may provide a “cat” combined content, in which “cat body” and “cat tail” contents combinable with the “cat head” content are combined with the “cat head”, to the input window of the chat room.

As another example, the user terminal 10 may display a randomly recommended combined content from the server 20 in the input window of the chat room. Specifically, the server 20 may receive a request to randomly recommend at least one combined content from the user terminal 10. When the server 10 receives such a request for random recommendation, the server 10 may provide a randomly recommended combined content to the user terminal 20. The request to randomly recommend at least one combined content may be made through a random recommendation interface.

For instance, the user terminal 10 may display the random recommendation interface in a content input area. When the server 20 receives an interaction with the random recommendation interface from the user terminal 10, the server 10 may provide any randomly recommended combined content to the input window of the chat room. In some cases, the user terminal 10 may display a randomly recommended combined content in the content input area rather than the input window of the chat room.

In operation 1305, the server 20 provides a message including a combined content to a chat interface. Since operation 1305 is substantially identical to operations 205 and 207 of FIG. 2, the description of operation 1305 is replaced with the description of operation 205 and operation 207 of FIG. 2.

In operation 1307, the server 20 provides an interface related to the combined content to the user terminal 10. Since operation 1307 is substantially identical to operation 209 of FIG. 2, the description of operation 1307 is replaced with the description of operation 209 of FIG. 2.

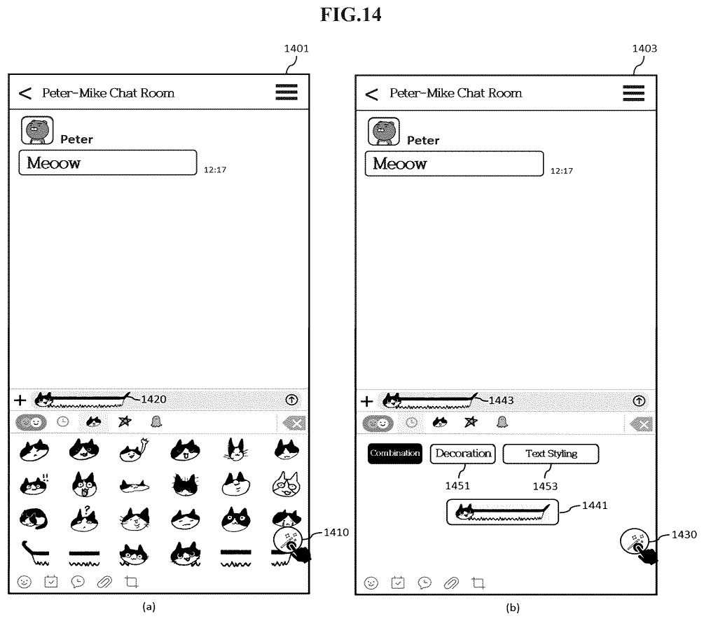

FIG. 14 is an example screen in which a server 20 according to one embodiment of the present disclosure provides a combined content to an input window of a chat room in response to a request from a user terminal 10.

Referring to (a) of FIG. 14, the user terminal 10 may display an automatic combination interface 1410 in a content input area. The automatic combination interface 1410 may be an interface capable of combining at least one content satisfying a combination condition. The user terminal 10 may receive an interaction with a specific content from a user. In this case, the user terminal 10 may display the specific content in the input window of the chat room. When the user terminal 10 receives an interaction with the automatic combination interface 1410 from the user, the user terminal 10 may display at least one content 1421 among combined contents satisfying a combination condition within a corresponding tab in the input window of the chat room.

For example, the user terminal 10 may receive an interaction with a “cat head” content from the user. In this case, the user terminal 10 may display the “cat head” content in the input window of the chat room. When the user terminal 10 receives an interaction with the automatic combination interface 1410 from the user, the user terminal 10 may display a “cat” combined content 1421 in the input window of the chat room by combining the “cat head” content with any content satisfying a combination condition. The content satisfying the combination condition may be at least one candidate content included in a Cat tab.

Referring to (b) of FIG. 14, the user terminal 10 may display a random recommendation interface 1430 in the content input area. The random recommendation interface 1430 may be an interface that randomly recommends at least one combined content among all combined contents. When the server 20 receives an interaction with the random recommendation interface 1430 from the user terminal 10, the server 20 may provide randomly recommended combined contents 1441 and 1443 to the user terminal 10. In this case, the user terminal 10 may display the randomly recommended combined contents 1441 and 1443 in the content input area or input window of the chat room.

When the user terminal 10 displays the randomly recommended combined content 1441 in the content input area, the user terminal 10 may modify or edit the randomly input combined content 1441. Specifically, the user terminal 10 may modify or edit a combined content 1451 through a decoration interface 1451 or text styling interface 1453 included in the content input area.

The present disclosure has the advantage of providing a messaging service user with a feature to combine contents, thereby allowing the user to store a combination of desired contents and conveniently use the stored combination of contents.

The present disclosure also has the advantage of recommending a content appropriate to a text input by a messaging service user and providing any other contents combinable with a content input by the user, thereby enabling easy combination of contents to make up a combined content.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiment and the accompanying drawings, and various modifications and changes may be made in view of the person skilled in the art to which the present disclosure pertains. The scope of the present disclosure should, therefore, be defined by equivalents to the claims, as well as the claims of the present disclosure.

What is claimed is:

1. A method for displaying a combined content in a messaging service by a user terminal, the method comprising:
displaying candidate contents in a content input area;
receiving selection interactions with a plurality of contents among the candidate contents;
displaying a combined content in which the plurality of contents are combined on a chat interface; and
displaying an interface related to the combined content on the chat interface.

2. The method of claim 1, wherein in displaying the interface related to the combined content, the user terminal displays the interface related to the combined content in a content input area included in the chat interface.

3. The method of claim 1, further comprising displaying the combined content on the chat interface in response to an interaction with the interface related to the combined content.

4. The method of claim 3, wherein displaying the combined content on the chat interface in response to an interaction with the interface related to the combined content comprises:
displaying the combined content in an input window of the chat interface in response to the interaction with the interface related to the combined content; and
displaying the combined content in a chat window of the chat interface in response to receiving a transmission interaction regarding the input window.

5. The method of claim 1, wherein in displaying the combined content, the user terminal displays the combined content when the plurality of contents satisfy a predetermined combination condition.

6. The method of claim 5, wherein displaying the combined content comprises:
displaying the combined content in an input window of the chat interface when the plurality of contents satisfy the predetermined combination condition; and
displaying the combined content in a chat window of the chat interface when a transmission interaction regarding the input window is received.

7. The method of claim 5, wherein receiving the selection interaction comprises:
receiving a selection interaction with a first content that is at least one of the candidate contents; and
displaying recommendation information on a second content satisfying the combination condition related to the first content.

8. The method of claim 5, wherein in displaying the combined content, the combined content is displayed on the chat interface in a different manner from other contents that do not satisfy the combination condition.

9. The method of claim 5, further comprising:
obtaining a request to designate the plurality of contents as a custom combined content when the plurality of contents do not satisfy the combination condition; and
displaying an interface related to the custom combined content on the chat interface.

10. The method of claim 1, wherein the interface related to the combined content is displayed as either the combined content or any one of the plurality of contents.

11. The method of claim 1, further comprising:
in response to an interaction with the interface related to the combined content, displaying the combined content together with a related content in the content input area;
receiving a selection interaction with any one of the combined content and the related content; and
displaying the any one of the combined content and the related content on the chat interface.

12. The method of claim 11, wherein the related content is a content comprising at least some of the plurality of contents that make up the combined content.

13. The method of claim 1, wherein in displaying the combined content, the combined content is displayed on the chat interface in a manner that is dependent on at least one of a size, a length, and a count of individual contents that make up the combined content.

14. The method of claim 1, wherein displaying the interface related to the combined content comprises:
obtaining an input of a text related to the combined content through an input window of the chat interface; and
in response to the input of the text, displaying the interface related to the combined content in the content input area.

15. The method of claim 1, wherein displaying the interface related to the combined content comprises displaying the interface related to the combined content in a content input area of a different chat interface from the chat interface.

16. The method of claim 1, wherein in displaying the interface related to the combined content, the interface related to the combined content is displayed as at least one of the user's recently used contents and favorite contents.

17. The method of claim 1, wherein:
the candidate contents comprise at least one of first-type contents combinable with each other and second-type contents not combinable with each other,
the content input area comprises at least one of an interface capable of displaying the first-type contents and an interface capable of displaying the second-type contents, and
the interface capable of displaying the first-type contents and the interface capable of displaying the second-type contents are displayed separately from each other.

18. A method for providing a combined content by a server in a messaging service, the method comprising:
providing candidate contents to a user terminal through a content input area;
receiving from the user terminal a transmission request for a combined content, in which a plurality of contents are combined among the candidate contents;
providing a message comprising the combined content to a chat interface; and
providing an interface related to the combined content to the user terminal.

19. The method of claim 18, wherein receiving the transmission request for the combined content comprises:
receiving from the user terminal a request to combine a first content input by a user with any content satisfying a predetermined combination condition, the first content being at least one of the candidate contents;
providing the user terminal with an automatically combined content in which the first content and at least one content satisfying the combination condition; and
receiving a transmission request for the automatically combined content from the user terminal.

20. The method of claim 18, wherein receiving the transmission request for the combined content comprises:
receiving from the user terminal a request to randomly recommend at least one combined content;
providing the at least one randomly recommended combined content to the user terminal; and
receiving a transmission request for the at least one randomly recommended combined content from the user terminal.
